(19) United States
(12) Patent Application Publication
(10) Pub. No.: US 2023/0135810 A1
(43) Pub. Date: May 4, 2023

(54) STRETCHABLE TEAT

(71) Applicant: Mattityahu AVSHALOMOV, Ramat Gan (IL)

(72) Inventor: Mattityahu AVSHALOMOV, Ramat Gan (IL)

(21) Appl. No.: 18/088,903

(22) Filed: Dec. 27, 2022

Related U.S. Application Data
(63) Continuation-in-part of application No. PCT/IL20/50671, filed on Jun. 17, 2020.
(60) Provisional application No. 62/863,314, filed on Jun. 19, 2019.

(51) Int. Cl. A61J 11/04

(52) U.S. Cl. CPC A61J 11/045

(57) ABSTRACT

An elastic teat for fitting over liquid containers, including a nipple for sucking liquid; an intermediate portion; and a lower portion of stretchable diameter; wherein the lower portion is configured to fit over a mouth of the container, providing a hermetic seal over a perimeter of the container. In embodiments, the teat further includes a securing mechanism adapted for securing said lower portion to the container.

### FIELD OF THE INVENTION

The present invention generally pertains to artificial, elastic teats used for feeding infants or babies. More specifically, the present invention relates to a stretchable teat composed of elastic materials, which can be readily adapted to fit and tightly seal a range of receptacles, regardless of their size and capacity.

### BACKGROUND OF THE INVENTION

In a case where a mother does not breastfeed or is not present, the baby or the infant is usually fed with expressed breast milk, formulas or other liquids or solutions, using baby feed bottles. A typical bottle comprises an elongate, necked receptacle, containing fluid sustenance and a teat, consisting of a nipple and a collar. The teat is supposed to mimic as best as possible the natural structure and feel of the human breast, and is to be placed within the infant's mouth. The teat can be assembled to or disassembled from the vessel, which contains the feed. The conventional teats are made of elastomeric materials, such as silicone, latex or TPE, and have a passage and an opening through which the baby sucks the fluid.

Patent U.S. Pat. No. 6,871,751 describes a baby bottle nipple, comprising a sealing surface adapted to be fastened on a baby bottle.

Patent U.S. Pat. No. 8,528,756 discloses a leakproof closure sealing system for baby bottles comprising a lower and an upper closure rings and locking elements for fastening the feeding teat to the bottle.

The above referenced patents describe means for fastening an artificial teat to a feeding bottle, but they do not disclose a stretchable elastic teat, that is fitted over a range of commonly used containers.

Patent U.S. Pat. No. 5,673,806 discloses a teat for a baby's bottle, whose nipple is fitted with dynamic means designed to implement a spring effect to enable axial stretching of the nipple. Patent U.S. Pat. No. 5,673,806 describes a teat that can be extended vertically, but does not disclose a teat that stretches horizontally and therefore, can be placed over various available containers and receptacles.

Although baby bottles come in a variety of styles and shapes, the designated commercial bottles are relatively costly, they ought to be specifically purchased in great quantities and their narrow structure can make it difficult to properly clean and sterilize them.

In light of the above, there remains a long felt and unmet need to provide improved inexpensive teats for feeding infants and babies that can be used with a variety of available containers.

### SUMMARY OF THE INVENTION

The present invention provides an elastic teat for baby feeding, that can stretch and fit many different types of available containers. Furthermore, the teat is equipped with a special fastener, assisting in tightening the teat once it is placed on top of a container. Details are disclosed below.

It is thus an object of the present invention to provide an elastic teat for fitting over liquid containers, comprising a nipple for sucking liquid, an intermediate portion and a lower portion of a stretchable diameter for fitting over the mouth of a container, configured to provide a hermetic seal over perimeter of the container.

According to features, the teat further includes a securing mechanism adapted for securing said lower portion to the container.

According to further features, the securing mechanism includes a band clamp of generally circular shape having free ends, with each of said free ends of the band clamp bent at right angles to the plane of the clamp. According to still further features, the band clamp is a self-tightening spring band clamp. According to still further features, arms of the clamp are adapted to be notched together.

It is also an object of the present invention to provide an elastic teat wherein the securing mechanism includes a tongue for tightening the stretchable lower portion to the mouth of a container and the free end of the tongue is configured to be fastenable to a fastening anchor on the stretchable lower portion after it is sealably attached to the container.

It is another object of the present invention to provide an elastic teat wherein the stretchable lower portion is horizontally and diametrically stretchable across the mouth of a container.

It is also an object of the present invention to provide an elastic teat wherein the diameter of the stretchable lower portion is greater than that of the nipple.

It is also an object of the present invention to provide an elastic teat wherein the nipple is configured to be received within an infant's or a baby's mouth and the nipple has an opening in its upper end to allow liquid flow.

It is also an object of the present invention to provide an elastic teat wherein the teat is made of a material selected from the group consisting of rubber, latex, thermoplastic elastomers (TPE) and silicone or any combination thereof.

It is also an object of the present invention to provide an elastic teat wherein the fastening anchor on the stretchable lower portion is configured as a protrusion or a stud.

A further object of the present invention is to provide a method of utilizing an elastic teat comprising steps of obtaining an elastic teat for fitting over liquid containers, the teat comprises a nipple for sucking liquid, an intermediate portion and a lower portion of a stretchable diameter for fitting over the mouth of a container configured to provide a hermetic seal over perimeter of the container and feeding an infant therefrom.

According to features, the elastic teat further includes a securing mechanism adapted for securing said lower portion to the container and the method further includes the step of securing said lower portion to said liquid container, using said securing mechanism.

It is also an object of the present invention to provide a method wherein the securing mechanism includes a tongue for tightening the stretchable lower portion to the mouth of a container and the free end of the tongue is configured to be fastenable to a fastening anchor on the stretchable lower portion after it is sealably attached to said container.

According to further features, the securing mechanism includes a band clamp of generally circular shape having free ends, with each of said free ends of the band clamp bent at right angles to the plane of the clamp. According to still further features, the band clamp is a self-tightening spring band clamp. According to still further features, arms of the clamp are adapted to be notched together.

It is also an object of the present invention to provide a method wherein the stretchable lower portion is horizontally and diametrically stretchable across the mouth of the container.

It is another object of the present invention to provide a method wherein the diameter of the stretchable lower portion is greater than that of the nipple.

It is also an object of the present invention to provide a method wherein the elastic nipple is configured to be received within an infant's or a baby's mouth and the nipple has an opening in its upper end to allow liquid flow.

It is another object of the present invention to provide a method wherein the elastic teat is made of a material selected from the group consisting of rubber, latex, thermoplastic elastomers (TPE) and silicone or any combination thereof.

It is another object of the present invention to provide a method wherein the fastening anchor is configured as a protrusion or a stud.

It is also an object of the present invention to provide a method consisting of manually stretching and fitting the stretchable lower portion of the elastic teat to the mouth of a container filled with any liquid suited for feeding a baby or an infant.

Rationale of the present invention:

There is a need to provide an elastic, adjustable nipple, which can be can be fitted over any commonly found liquid containing receptacle or vessel, regardless of its size or capacity, thus rendering the feeding process more affordable and convenient. The present invention discloses means and methods for providing same.

### BRIEF DESCRIPTION OF THE DRAWINGS

FIG. 1 is a schematic illustration of an aspect of the present invention;

FIG. 2 is a schematic illustration of an aspect of the present invention;

FIG. 3 is a schematic illustration of an aspect of the present invention;

FIG. 4 is a schematic illustration of an aspect of the present invention;

FIG. 5 is a schematic illustration of an aspect of the present invention;

FIG. 6 is a schematic illustration of an aspect of the present invention;

FIG. 7 is a schematic illustration of an aspect of the present invention;

FIG. 8 is a schematic illustration of an aspect of the present invention;

FIG. 9 is a schematic illustration of an aspect of the present invention;

FIG. 10 is a schematic illustration of an aspect of the present invention;

FIG. 11 is a schematic illustration of an aspect of the present invention;

FIG. 12 is a schematic illustration of an aspect of the present invention;

FIG. 13 is a schematic illustration of an aspect of the present invention;

FIG. 14A is a schematic illustration of an example embodiment of the present invention in a notched state; and

FIG. 14B is a schematic illustration of an example embodiment of the present invention in an open state.

### DETAILED DESCRIPTION OF THE DRAWINGS

The following descriptions are provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide an elastic teat 100 for fitting over liquid containers particularly versatile utility.

Reference will now be made in detail to the preferred embodiments of the present invention, examples of which are illustrated in the accompanying drawings.

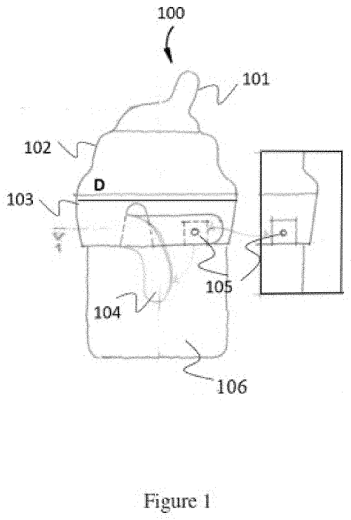

Reference is now made to FIG. 1 illustrating an object of the present invention: an elastic teat 100 for fitting over liquid containers 106, comprising a nipple 101 for sucking liquid, an intermediate portion 102 and a lower portion 103 of stretchable diameter D for fitting over the mouth of the container 106, configured to provide a hermetic seal over the perimeter of the container 106. Stretchable lower portion 103 comprises a tongue 104 for tightening the lower portion 103 to the mouth of a container 106 and the free end of the tongue 104 is configured to be fastenable to a fastening anchor 105 on the stretchable lower portion 103 after it is sealably attached to the container 106.

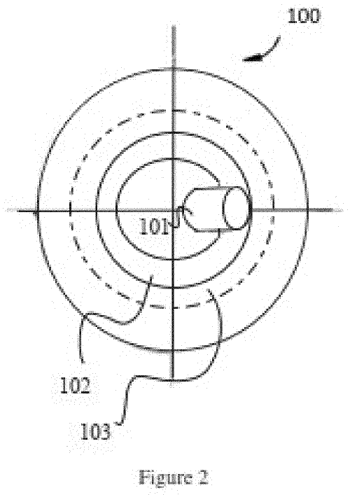

Reference is now made to FIG. 2 illustrating a top plan view of the present invention: the elastic teat 100 comprises a nipple 101 for sucking liquid, an intermediate portion 102 and a stretchable lower portion 103.

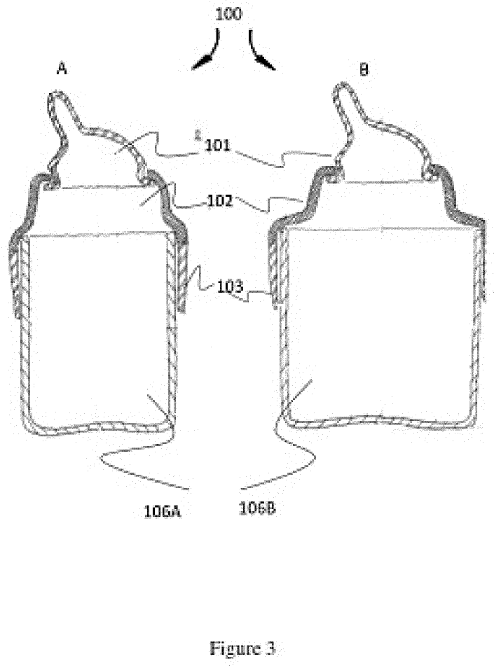

Reference is now made to FIG. 3 illustrating longitudinal cross sections of the present invention, wherein elastic teat 100 comprising a nipple 101 for sucking liquid, an intermediate portion 102 and a stretchable lower portion 103, is fitted over two different containers 106A and 106B.

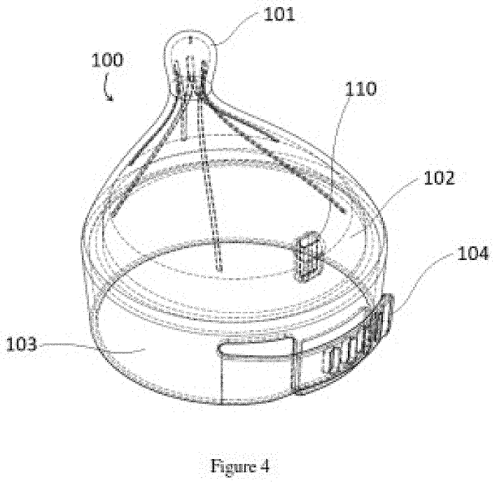

Reference is now made to FIG. 4 illustrating a side view of the present invention in an in-use condition, wherein elastic teat 100 comprising a nipple 101 for sucking liquid, an intermediate portion 102 and a stretchable lower portion 103, is partially received within an infant's mouth and is sealably attached and fastened to a container 106 with a tongue 104, which is fixed to a fastening anchor 105.

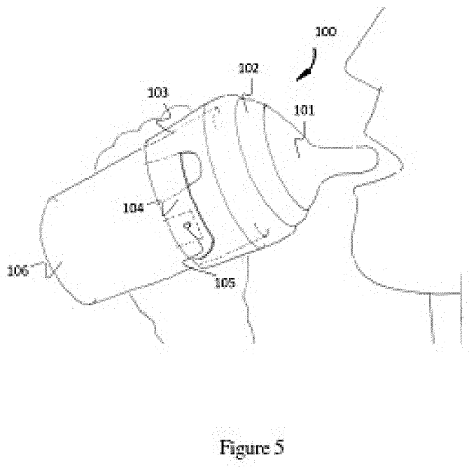

Reference is now made to FIG. 5 illustrating an example of the present invention 100 provided with aperture 110 configured for compensating rarefaction of air withing the container (not show) during sucking nipple 101.

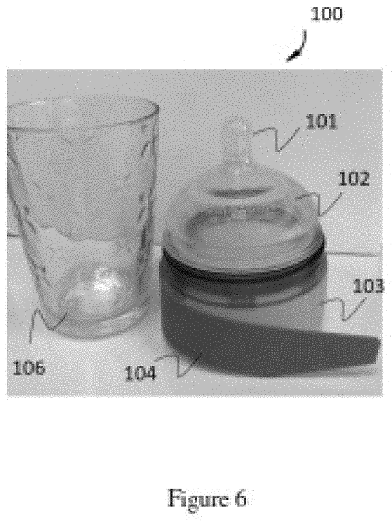

Reference is now made to FIG. 6 illustrating an example of the present invention prior to fitting and stretching it over a container: an elastic teat 100 comprising a nipple 101 for sucking liquid, an intermediate portion 102, a stretchable lower portion 103 and a tongue 104, next to a container 106 of choice.

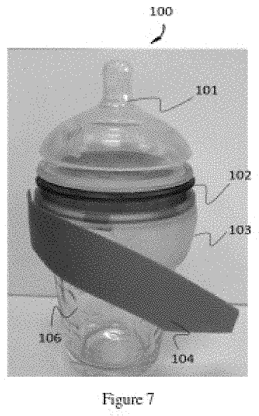

Reference is now made to FIG. 7 illustrating an example of the present invention. The elastic teat 100 comprising a nipple 101 for sucking liquid, an intermediate portion 102 and a stretchable lower portion 103, is fitted over a container 106 of choice. The tongue 104 located on lower portion 103, is not yet fastened to hermetically seal the teat 100.

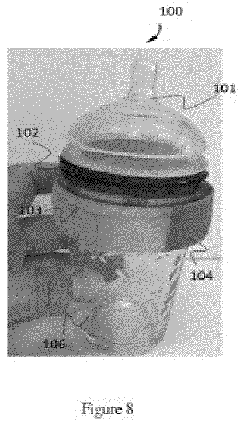

Reference is now made to FIG. 8 illustrating an example of the present invention. The elastic teat 100 comprising a nipple 101 for sucking liquid, an intermediate portion 102 and a stretchable lower portion 103, is fitted over a container 106 of choice and is tightly connected to it by tongue 104, which is fastened to stretchable lower portion 103 of teat 100.

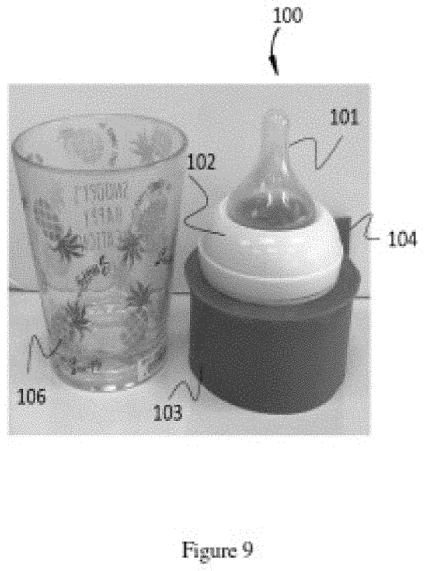

Reference is now made to FIG. 9 illustrating an example of the present invention prior to fitting and stretching it over a container: an elastic teat 100 comprising a nipple 101 for sucking liquid, an intermediate portion 102, a stretchable lower portion 103 and a tongue 104, next to a container 106 of choice.

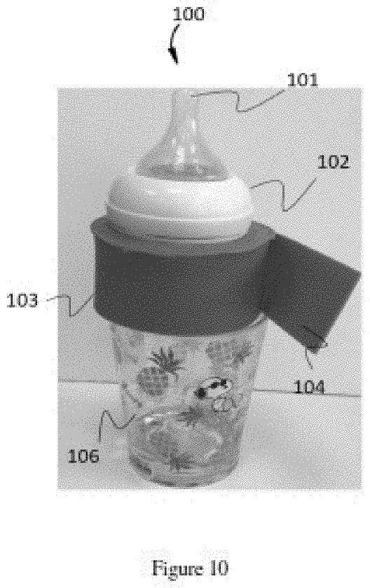

Reference is now made to FIG. 10 illustrating an example of the present invention. The elastic teat 100 comprising a nipple 101 for sucking liquid, an intermediate portion 102 and a stretchable lower portion 103 is fitted over a container 106 of choice. The tongue 104 located on stretchable lower portion 103, is not yet fastened to hermetically seal the teat 100.

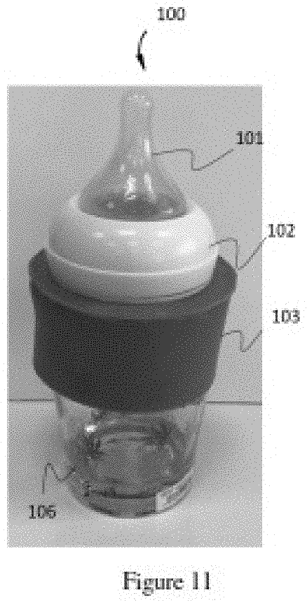

Reference is now made to FIG. 11 illustrating an example of the present invention. The elastic teat 100 comprising a nipple 101 for sucking liquid, an intermediate portion 102 and a stretchable lower portion 103, is fitted over a container 106 of choice and is tightly connected to it.

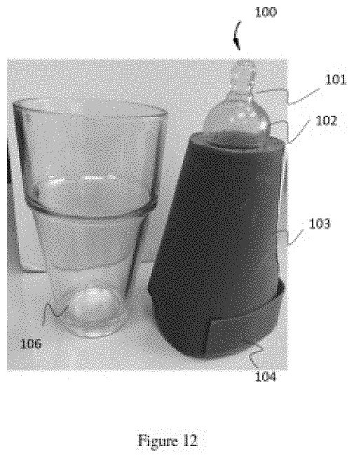

Reference is now made to FIG. 12 illustrating an example of the present invention prior to fitting and stretching it over a container: an elastic teat 100 comprising a nipple 101 for sucking liquid, an intermediate portion 102, a stretchable lower portion 103 and a tongue 104, next to a container 106 of choice.

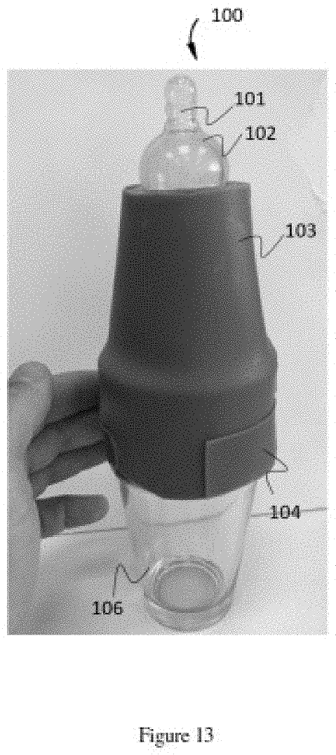

Reference is now made to FIG. 13 illustrating an example of the present invention. The elastic teat 100 comprising a nipple 101 for sucking liquid, an intermediate portion 102 and a stretchable lower portion 103, is fitted over a container 106 of choice and is tightly sealed to it by tongue 104.

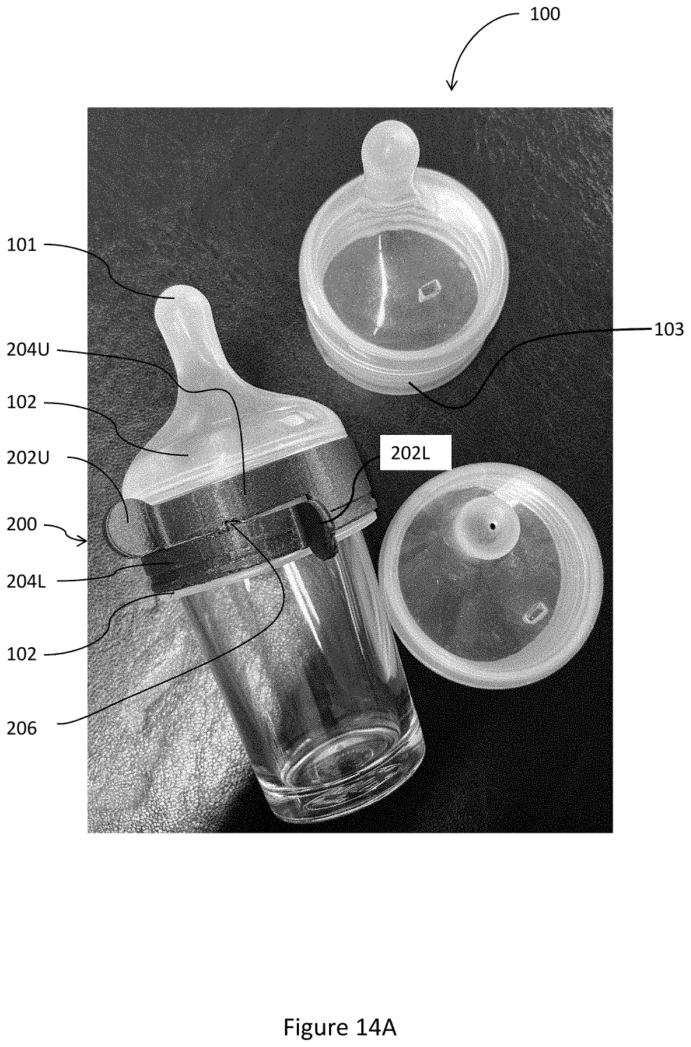

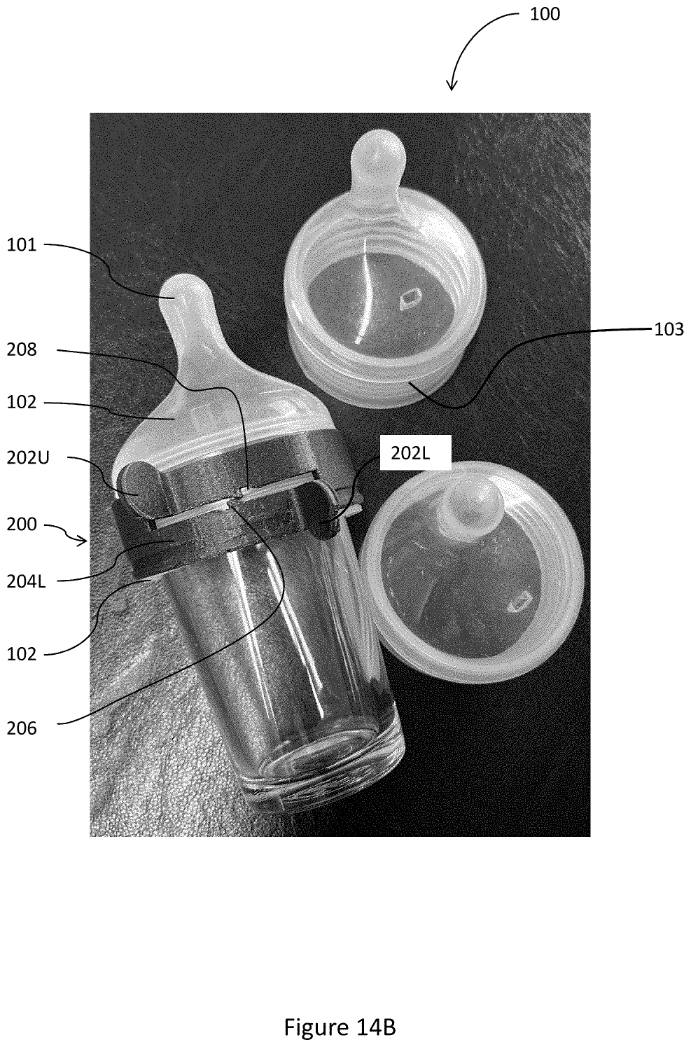

Reference is now made to FIGS. 14A and 14B which illustrate an example embodiment of the present invention. The elastic teat 100 comprising a nipple 101 for sucking liquid, an intermediate portion 102 and a stretchable lower portion 103, is fitted over a container 106 of choice and is tightly secured to it by a securing mechanism 200. In FIG. 14A the securing mechanism is in a locked state and in FIG. 14B the securing mechanism is in an unlocked state.

According to one embodiment, the securing mechanism is a band clamp 200 of generally circular shape having free ends 202U, 202L, with each of said free ends of the band clamp bent at right angles to the plane of the clamp. The band clamp may be a self-tightening spring band clamp where the diameter of the band is enlarged by squeezing the free ends 202U and 202L together (e.g., using a thumb and forefinger in a pincer grip).

In the example embodiment depicted in FIGS. 14A and 14B, the clamp is a band clamp with two arms 204, an upper arm 204U and a lower arm 204L. It is made clear that any configuration of the clamp, with any number of arms is considered to be within the scope of the invention.

The arms of the instant, example clamp 200 are adapted to be notched together by interlocking protrusions 206 that extend from each arm. Next to each protrusion is a valley or inlet 208 into which the opposing protrusion fits. In embodiments, in the resting, unlocked state of the clamp 200 the notches or protrusions 206 are separated from each other and it is necessary to push the bend ends away from each other in order to clasp the protrusions together.

In embodiments (not shown), there are more that one notch 206, to facilitate securing the teat to containers of various diameters.

While the invention has been described with respect to a limited number of embodiments, it will be appreciated that many variations, modifications and other applications of the invention may be made. Therefore, the claimed invention as recited in the claims that follow is not limited to the embodiments described herein.

1. An elastic teat for fitting over liquid containers, comprising:
a. a nipple for sucking liquid;
b. an intermediate portion;
c. lower portion of stretchable diameter;
wherein said lower portion is configured to fit over a mouth of the container, providing a hermetic seal over a perimeter of the container.

2. The teat of claim 1, further comprising:
d. a securing mechanism adapted for securing said lower portion to the container.

3. The teat according to claim 2, wherein said securing mechanism includes:
i. a tongue for tightening said lower portion to said mouth of the container;
ii. a free end of said tongue, said free end configured to be fastenable to a fastening anchor on said lower portion after said lower portion is sealably attached to said container.

4. The teat according to claim 2, wherein said securing mechanism comprises a band clamp of generally circular shape having free ends, with each of said free ends of the band clamp bent at right angles to the plane of the clamp.

5. The teat according to claim 4, wherein the band clamp is a self-tightening spring band clamp

6. The teat according to claim 4, wherein arms of the clamp are adapted to be notched together.

7. The teat according to claim 1, wherein said lower portion is horizontally and diametrically stretchable across the mouth of said container.

8. The teat according to claim 1, wherein diameter of said lower portion is greater than that of said nipple.

9. The teat according to claim 1, wherein said teat is made of a material selected from the group consisting of rubber, latex, thermoplastic elastomers (TPE) and silicone or any combination thereof.

10. The teat according to claim 3, wherein the fastening anchor is configured as a protrusion or a stud.

11. A method of utilizing a teat comprising steps of
a. obtaining an elastic teat for fitting over liquid containers
said elastic teat comprising:
i. a nipple for sucking liquid,
ii. an intermediate portion,
iii. a lower portion of stretchable diameter;
b. manually stretching said lower portion over the mouth of said liquid container; and
c. feeding an infant or a baby therefrom.

12. The method according to claim 11, the elastic teat further comprises:
iv. a securing mechanism adapted for securing said lower portion to the container;
and the method further comprises the step of:
d. securing said lower portion to said liquid container, using said securing mechanism.

13. The method according to claim 12, wherein said securing mechanism comprises a tongue for tightening said lower portion to the mouth of said container; free end of said tongue is configured to be fastenable to a fastening anchor on said lower portion after said lower portion is sealably attached to said container.

14. The method according to claim 12, wherein said securing mechanism comprises a band clamp of generally circular shape having free ends, with each of said free ends of the band clamp bent at right angles to the plane of the clamp.

15. The method according to claim 14, wherein the securing mechanism is a self-tightening spring band clamp.

16. The method according to claim 14, wherein arms of the clamp are adapted to be notched together.

17. The method according to claim 11, wherein said lower portion is horizontally and diametrically stretchable across the mouth of said container.

18. The method according to claim 11, wherein diameter of said lower portion is greater than that of said nipple.

19. The method according to claim 11, wherein said teat is made of a material selected from the group consisting of rubber, latex, thermoplastic elastomers (TPE) and silicone or any combination thereof.

20. The method according to claim 11, wherein said fastening anchor is configured as a protrusion or a stud.
